(19) United States
(12) Patent Application Publication
(10) Pub. No.: US 2008/0079183 A1
(43) Pub. Date: Apr. 3, 2008

(54) METHOD FOR MAKING AN OPTICAL ELEMENT

(75) Inventors: Mao-Song Lee, Hsin Chu City (TW); Hsi-Hsin Shih, Taichung City (TW); Chin-Lung Kuo, Tainan City (TW); Shih-Kai Cheng, Yi Lan City (TW); Shen-Yin Tsai, Tainan City (TW); Jun-Hong Lin, Tainan County (TW)

Correspondence Address: OSTROLENK FABER GERB & SOFFEN, 1180 AVENUE OF THE AMERICAS, NEW YORK, NY, 100368403, US

(73) Assignee: CHI LIN TECHNOLOGY CO., LTD., Tainan County (TW)

(21) Appl. No.: 11/536,437

(22) Filed: Sep. 28, 2006

(51) Int. Cl. B29D 7/01; B29D 11/00

(52) U.S. Cl. 264/1.34; 264/1.36; 264/1.38

(57) ABSTRACT

A method for making an optical element includes the steps of: coating a curable resin on a substrate so as to form a curable resin layer on the substrate; embossing the curable resin layer so as to form a plurality of micro-protrusions thereon; and exposing the curable resin layer directly to a power source so as to cure the curable resin layer.

### BACKGROUND OF THE INVENTION

1. Field of the Invention

This invention relates to a method for making an optical element, more particularly to a method involving embossing a resin layer to form a plurality of micro-protrusions thereon for making the optical element.

2. Description of the Related Art

A diffuser plate and a brightness-enhancing sheet of a liquid crystal display, a reflective plate, an optical plate for holo-photograph, and a reflective plate for road use are normally required to have a patterned surface with a plurality of micro-structures formed thereon. The configuration of the micro-structure varies with the actual requirements.

As illustrated in FIGS. 1 and 2, U.S. Pat. No. 3,689,346 discloses a conventional method for making an optical element 10. In the conventional method, a roller 11 provided with a patterned micro-structure thereon is used for forming a corresponding micro-structure 102 on a curable resin layer, a plasticizer nozzle 12 is used for supplying a plasticizer, a resin nozzle 13 is used for supplying a curable resin for forming the curable resin layer, a plurality of UV light bulbs 17 are used for curing the curable resin layer, a cooling bath 16 is used for cooling the heated curable resin layer, and a releasing unit 15 is used for separating the curable resin layer from the roller 11. The patterned micro-structure of the roller 11 is formed with a plurality of recesses 111. In operation, the plasticizer is sprayed onto the patterned micro-structure of the roller 11 during rotation of the roller 11, and the curable resin is subsequently applied and fills the recesses 111 when the recesses 111 pass through the resin nozzle 13 so as to form the micro-structure 102 on the curable resin layer on the roller 11. An optical substrate 101 is then attached to the patterned curable resin layer using a reel unit 14, and the patterned curable resin layer covered with the optical substrate 101 is then cured by the UV light bulbs 17 and is cooled by the cooling bath 16 when passing therethrough. The cured resin layer attached with the optical substrate 101 is then separated from the roller 11 by a releasing wheel 151 of the releasing unit 15, and is wound on a reel.

The conventional method is disadvantageous in that the optical substrate 101 is required to be transparent and that since the optical substrate 101 is disposed between the UV light bulbs 17 and the cured resin layer, the layer thickness of the optical substrate 101 is required to be as thin as possible. Hence, thick optical substrates are not suitable for making the aforesaid optical element.

As illustrated in FIG. 3, U.S. Pat. No. 6,440,344 discloses another conventional method for making an optical element 10. The conventional method involves coating a reflective layer 22 on a micro-structure 211 on a substrate 21, forming a curable resin layer 24 on a transferring screen 23, transferring the reflective layer 22 to the curable resin layer 24 by pressing the transferring screen 23 against the reflective layer 22 on the substrate 21, and curing the curable resin layer 24 by radiating a UV light through the substrate 21 and the reflective layer 22 onto the curable resin layer 24. The conventional method has the same disadvantages of the aforesaid method disclosed in U.S. Pat. No. 3,689,346.

### SUMMARY OF THE INVENTION

Therefore, the object of the present invention is to provide a method for making an optical element that can overcome the aforesaid drawbacks of the prior art.

According to this invention, there is provided a method for making an optical element. The method comprises: coating a curable resin on a substrate so as to form a curable resin layer on the substrate; embossing the curable resin layer so as to form a plurality of micro-protrusions thereon; and exposing the curable resin layer directly to a power source so as to cure the curable resin layer.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a schematic view to illustrate how an optical element is made using an apparatus according to a conventional method;

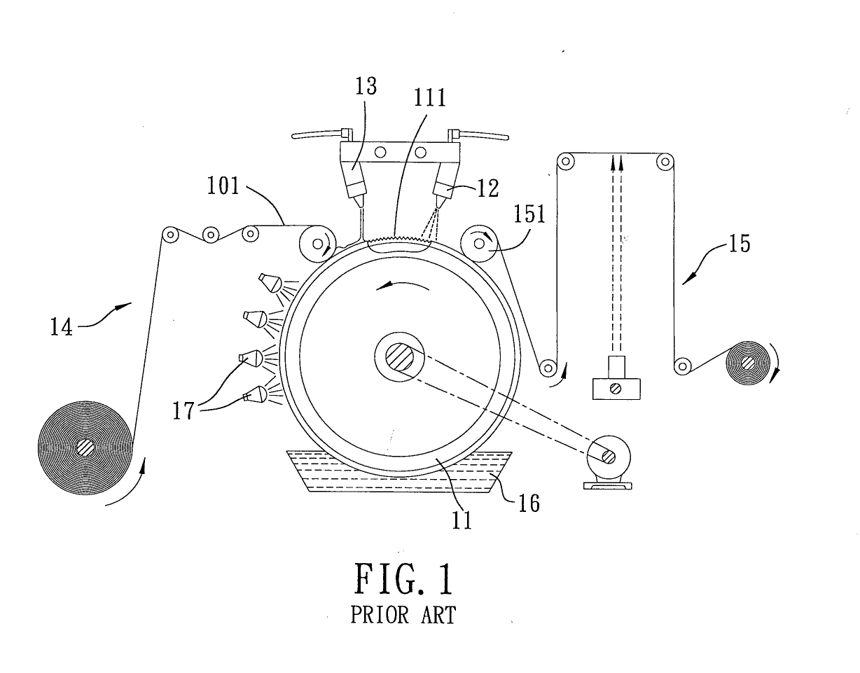

FIG. 2 is a fragmentary schematic sectional view of the optical element made by the apparatus shown in FIG. 1;

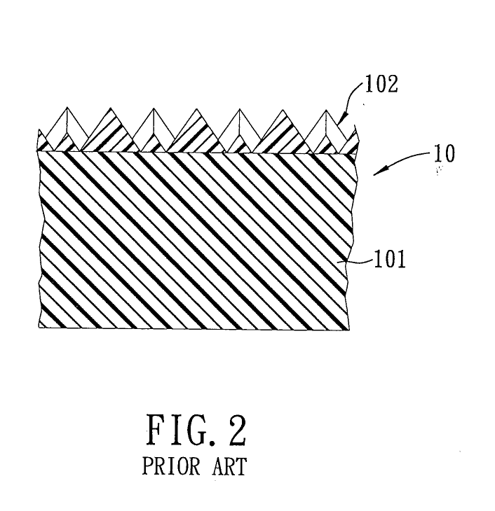

FIG. 3 is a fragmentary schematic sectional view to illustrate how an optical element is made using a transferring screen according to another conventional method;

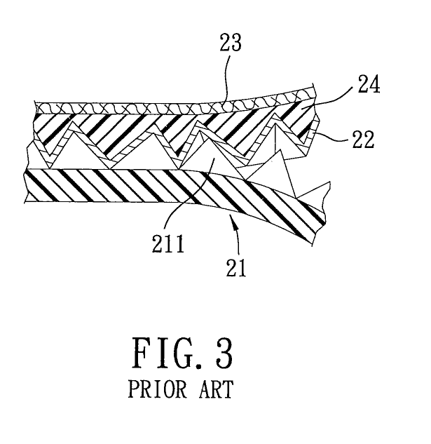

FIG. 4 is a schematic view illustrating consecutive steps of a method for making the first preferred embodiment of an optical element according to this invention; and

FIG. 5 is a fragmentary schematic sectional view to illustrate how the second preferred embodiment of the optical element is made using a roller according to the method of this invention.

### DETAILED DESCRIPTION OF THE PREFERRED EMBODIMENTS

Before the present invention is described in greater detail, it should be noted that same reference numerals have been used to denote like elements throughout the specification.

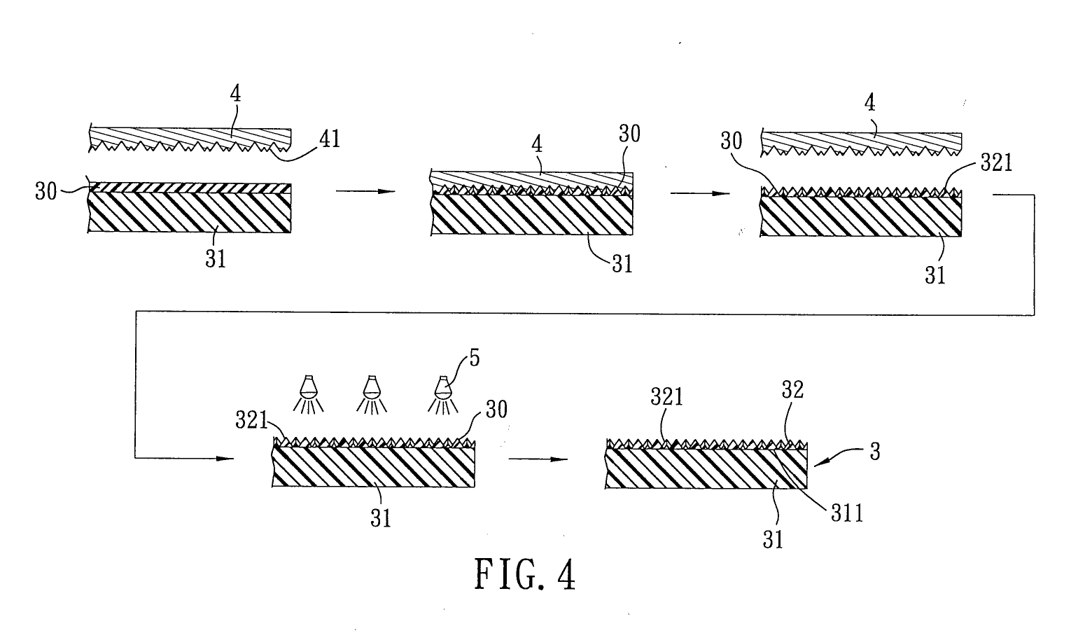

FIG. 4 illustrates consecutive steps of the first preferred embodiment of a method for making an optical element 3 according to this invention. The optical element 3 can be used as a diffuser plate or a brightness-enhancing sheet for a backlight module of a liquid crystal display, a reflective plate, an optical plate for holo-photograph, a reflective plate for road use, or the like.

The optical element 3 includes: a substrate 31; and a hardened resin layer 32 formed on a surface 311 of the substrate 31 and formed with a plurality of prism-like micro-protrusions 321.

The method for making the optical element 3 includes the steps of: coating a curable resin on the substrate 31 so as to form a curable resin layer 30 on the substrate 31; embossing the curable resin layer 30 so as to form a plurality of the micro-protrusions 321 thereon; and exposing the curable resin layer 30 directly to a power source 5 so as to cure the curable resin layer 30, thereby forming the hardened resin layer 32. Hence, unlike the aforesaid conventional methods in which the curable resin layers are indirectly exposed to a power source, i.e., the power source, such as a UV light or an E-beam, is required to pass through an optical substrate before reaching the curable resin layer, the curable resin layer 30 is directly exposed to the power source 5 in the method of this invention.

The substrate 31 is free of filler, and is preferably made from a material selected from the group consisting of polycarbonate, polyester, cyclo olefin copolymer, polymethylmethylacrylate, and titanium dioxide. The substrate 31 can be transparent or opaque based on the actual requirements.

The curable resin is preferably made from a resin selected from the group consisting of acrylic, epoxy, acrylic-epoxy, polyurethane, and silicone, and preferably has a layer thickness ranging from 1 μm to 1 mm, and more preferably ranging from 50 μm to 200 μm.

Application of the curable resin can be conducted by spinning coating techniques using a Carma coater, roller coating techniques using a roller coater, or die coating techniques using a die coater. In this embodiment, the curable resin is applied to the substrate 31 by roller coating techniques.

Formation of the micro-protrusions 321 is conducted using a planar press-molding plate 4 which is formed with a micro-structure 41 having a pattern corresponding to the structure of the micro-protrusions 321.

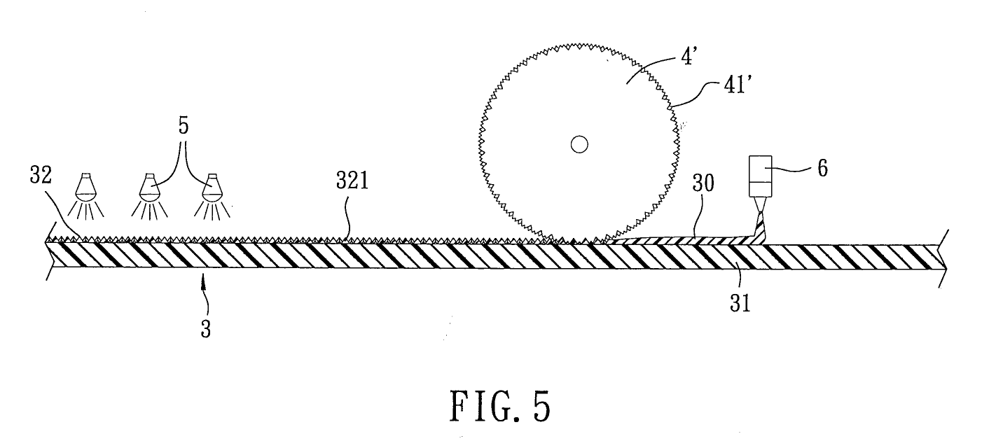

FIG. 5 illustrates the second preferred embodiment of the method for making the optical element 3 of this invention. The method of this embodiment differs from the previous embodiment in that formation of the micro-protrusions 321 is conducted using a roller 4′ provided with an annular micro-structure 41′ corresponding to the structure of the micro-protrusions 321. A resin nozzle 6 is used for applying the curable resin onto the substrate 31 prior to the pressing by the roller 4′. The substrate 31 is driven to move in sequence through the resin nozzle 6, the roller 4′, and the power source 5.

Since the curable resin layer 30 is directly exposed to the power source 5 according to the method of this invention, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for making an optical element, comprising:
coating a curable resin on a substrate so as to form a curable resin layer on the substrate;
embossing the curable resin layer so as to form a plurality of micro-protrusions thereon; and
exposing the curable resin layer directly to a power source so as to cure the curable resin layer.

2. The method of claim 1, wherein coating of the curable resin is conducted using a die coater.

3. The method of claim 1, wherein the layer thickness of the curable resin layer ranges from 1 μm to 1 mm.

4. The method of claim 3, wherein the layer thickness of the curable resin layer ranges from 50 μm to 200 μm.

5. The method of claim 1, wherein the curable resin is made from a resin material selected from the group consisting of acrylic, epoxy, acrylic-epoxy, polyurethane, and silicone.

6. The method of claim 1, wherein formation of the micro-protrusions on the curable resin layer is conducted using a planar press-molding plate.

7. The method of claim 1, wherein formation of the micro-protrusions on the curable resin layer is conducted using a roller provided with an annular micro-structure corresponding to the structure of the micro-protrusions.

8. The method of claim 1, wherein the power source for curing the curable resin layer is selected from the group consisting of UV light and E-beam.
